(19) United States
(12) Patent Application Publication
(10) Pub. No.: US 2011/0278097 A1
(43) Pub. Date: Nov. 17, 2011

(54) Shaft Element for an Elevator System

(75) Inventors: Stefan Altenburger, Filderstadt (DE); Markus Hanle, Erkenbrechtsweiler (DE)

(73) Assignee: ThyssenKrupp Elevator AG, Dusseldorf (DE)

(21) Appl. No.: 12/946,304

(22) Filed: Nov. 15, 2010

Related U.S. Application Data
(63) Continuation of application No. PCT/EP2009/003494, filed on May 15, 2009.

(30) Foreign Application Priority Data
May 16, 2008 (EP) 08 009 094.7

(51) Int. Cl. B66B 7/02; B66B 9/04; B23P 11/00; B66B 11/08

(52) U.S. Cl. 187/255; 187/406; 187/272; 29/428

(57) ABSTRACT

A shaft element for a shaft of an elevator system comprising a longitudinal strand element and a connection to a shaft, wherein the shaft element is divided into a plurality of partitions to each of which a function is assigned is presented.

The invention relates to a shaft element for a shaft of an elevator system, a longitudinal strand element for a shaft of an elevator system, a coupling element and a longitudinal strand for this application.

Elevators serve as usually stationary lift systems for persons and/or loads, wherein an elevator car is typically moved up and down in a guide.

An elevator consists of a plurality of modules in order to cover the bandwidth of its functional requirements. Many of these modules consist of two partial systems, namely a movable partial system and a stationary partial system. The stationary partial systems are either arranged at significant locations or along the shaft. Here, each of these components realizes specific tasks.

In known elevators, a combination of functions is only used to a limited extent. Consequently, most components are configured as autonomous units and also mounted as such.

This results in a considerable effort in the assembly and in the storage, leading to high costs.

The presented shaft element is designed to be used in a shaft of an elevator system and comprises a longitudinal strand element and a connection to a shaft. In this case, the shaft element or the longitudinal strand is divided into a plurality of partitions to each of which a function is assigned.

The described shaft element or shaft segment thus represents a device combining many of the above-mentioned stationary partial systems to a module. This module consists of a longitudinal strand element or longitudinal strand segment and a connection to the shaft. The module can be arranged in the shaft as one unit, as facing units, as diagonal units or in all four corners.

The shaft element realizes one or more of the following functions, for example:

a) providing running surfaces for elevator car guides,
b) providing emergency running surfaces for emergency running guides,
c) providing braking surfaces for catching devices and/or braking devices,
d) providing engagement surfaces for main drives. These engagement surfaces are identical with the running surfaces for the elevator car guides or they are configured as an individual partition. The main drive can be a friction wheel motor, a rack motor or a linear motor.
e) providing engagement surfaces for emergency drives. These engagement surfaces are identical with the running surfaces for the elevator car guides or they are configured as an individual partition. The emergency drive can be a friction wheel motor, a rack motor or a linear motor.

f) integrating and protecting the drive components such as carrier means, friction wheels, cogwheels or linear motor components,

g) providing stopping points for lifting gears. These stopping points can be arranged in the center-of-gravity axis of the module.
h) providing adjustment regions for controlling the correct alignment,
i) providing sensor signals for controlling the perpendicular alignment,
j) providing compensation regions for potential building subsidences,
k) providing compensation regions for potential temperature expansions,
l) providing mounting regions for other elevator components such as a shaft encoder and/or a shaft illumination and/or a lift cable attachment and/or linear motor components etc.,
m) providing a code for a shaft position encoder,
n) providing connecting elements for attachment at the shaft,
o) providing transmission media for data and energy.

The above-mentioned functions are also called passive functions.

According to a configuration, the shaft element provides a partition for the running surfaces for elevator car guides or emergency running guides. In this case, the running surfaces are different from the rest of the shaft element. Furthermore, the running surfaces can have an angle with respect to each other.

The running surfaces for the emergency running guide can be configured identically to the running surfaces for the elevator car guides or as independent running surfaces. Furthermore, the joint areas of the running surfaces between the shaft elements can be configured in an overlapping manner.

According to a configuration, a partition for the braking surfaces for catching devices or braking devices is provided. Herein, it is possible that the braking surfaces are different from the rest of the shaft element, that the braking surfaces are identical with the running surfaces for the elevator car guides or configured as independent running surfaces, that the braking surfaces include a different material than the filling body, that the thickness of the filling body can be varied so that the distance between the braking surfaces can be adjusted to the required rail head thickness of the catching devices or the required brake disk thickness of the braking device, and that the joints of the braking surfaces between the shaft elements are configured in an overlapping manner.

The above-described shaft element can be manufactured in different ways. Thus, the blanks of the individual components can be individually cut or stamped of sheet-metal plates or so-called tailored blanks and subsequently canted or shaped. Alternatively, the individual components can be fabricated from tubes which are pressed to their final shape by means of internal high-pressure forming. Another option provides that the individual components are fabricated from flats which are shaped by means of an extrusion facility and subsequently cut to length.

Furthermore, it is possible that the individual components are discontinuously fabricated as individual fiber-composite components. Moreover, the profiles of the individual components can be formed by means of a pultrusion technology and subsequently cut to length.

The assembly of the shaft element can be carried out in different ways. Thus, the individual modules can be stacked individually and connected to the shaft, wherein the connections to the shaft allow a sliding movement in the longitudinal direction. Alternatively, the individual modules are mounted one above the other in a suspended fashion in the shaft, wherein only one connection is stationary and the other connections enable a sliding in the longitudinal direction. According to another option, the individual modules are mounted one above the other in a suspended fashion in the shaft using a continuous connection which is sufficiently flexible to adapt to any unevenness of the shaft.

According to an alternative procedure, the strand is supplied in a flexible condition, rolled out in the shaft and then fixed in its final position, e.g. by curing or applying a vacuum. The individual components can furthermore be fabricated discontinuously as individual fiber composite components. Furthermore, the profiles of the components can be formed by means of an extrusion or pultrusion technology and subsequently cut to length.

According to a configuration of the shaft element, the connection consists of a continuous element. This connection compensates any unevenness of the shaft wall and guarantees a secure support of the longitudinal strand. Alternatively, the connection consists of several elements distributed over the longitudinal strand.

In use, the connection fixes the longitudinal strand in the horizontal directions and enables a vertical sliding movement. According to a particular embodiment, the connection also fixes the vertical direction. Here, the connection can be force-locking by means of adhesives or foams or form-locking by means of adjustable clamps or brackets.

Alternatively or additionally, at least one partition can be provided to which an active function is assigned. This means that an active element such as the drive is integrated into the shaft element. This can be a spindle drive, a timing belt drive, a silent chain drive, a linear motor, a rope drive, a hydraulic drive or a pneumatic drive, for example. In this case, the cabin to be transported has only passive functions. The active components of the drive are integrated into the shaft element.

Other functions to be realized can be the illumination such as the shaft illumination or a position determination.

The described longitudinal strand element serves for a shaft of an elevator system and is divided into a plurality of partitions to each of which a function is assigned.

According to a configuration of the longitudinal strand element, the partition for the main drive has an increased surface friction value.

Alternatively, the partition for the main drive has a toothing or a hole pattern.

The described longitudinal strand element can have at least one partition provided for aligning the longitudinal strand element in the shaft.

Furthermore, the longitudinal strand element can have at least one partition providing running surfaces for an elevator car guide or an emergency running guide.

According to a configuration, the longitudinal strand element has at least one partition providing braking surfaces for catching devices or braking devices.

Furthermore, at least one calibrating device can be provided.

According to a configuration, it can be provided that an active function is assigned to the at least one partition.

This means that an active element such as the drive is integrated into the shaft element. This can be a spindle drive, a timing belt drive, a silent chain drive, a linear motor, a rope drive, a hydraulic drive or a pneumatic drive, for example. In a timing belt drive, driven cogwheels are provided in a partition of the longitudinal strand element, for example. Cogwheels can be coupled to each other by a silent chain which in turn engages a rack mounted at a cabin for transporting the cabin.

The cogwheels can be driven directly. Alternatively, a drive or motor driving the cogwheels and thus the silent chain can be provided at an arbitrary location, e.g. at the upper or lower part of the shaft.

In this case, the cabin to be transported has only passive functions. The active components of the drive are integrated into the shaft element.

Other functions to be realized can be the illumination such as the shaft illumination or a position determination. The position determination can be carried out by means of a positioning unit operating with or without contact. In this context, optical or magnetical units are favorable.

Partitions for passive functions, as initially mentioned, and partitions for active functions can of course be provided.

The presented coupling element serves for coupling two longitudinal strand elements, wherein joint areas of the two elements are connected to each other by the coupling element.

This coupling element can have a device or means for force transmission. In a silent chain drive, this is a cogwheel, for example, which couples cogwheels of both longitudinal strand elements to be coupled so that a force transmission occurs. However, the coupling elements also offer the option that no force transmission occurs. In this manner, individual longitudinal strand elements or a series of adjacent longitudinal strand elements can be driven independently. This enables the use of several independent cabins or cars in an elevator shaft (multi-car).

In a hydraulic drive, the coupling element is provided with valves, for example.

The presented longitudinal strand is provided for a shaft of an elevator system and comprises a number of the above-described longitudinal strand elements.

This longitudinal strand typically consists of a thin-walled material. The cross-section of the profile of the longitudinal strand can have both an open and a closed configuration. This is a significant difference with respect to conventional guide rails which are made of a homogenous material so that novel aspects with respect to the fabrication, logistics, assembly and maintenance also show up.

The joint areas between the longitudinal strand elements can be configured in an overlapping manner, at least limited to particular partitions.

The overlap can follow a tongue and groove principle.

A coupling element of the above-described type can be provided between at least two of the longitudinal strand elements. This is significant in particular in the assembly. In this case, initially a first longitudinal strand element or shaft element can be mounted, and then the drive, e.g. a cogwheel, can be mounted at this element. This cogwheel can be driven directly or via a central motor. The subsequent strand element is then mounted via a coupling element. Then the cabin is mounted. It can be fixed by means of an assembly positioning device which may be merely mechanically. This assembly device also helps in a later maintenance. The longitudinal strand can thus be mounted step by step with an already assembled cabin. The cabin then also serves as a working platform. Scaffolds can be dispensed with in this manner.

Because the individual strand elements can be decoupled from the drive by coupling elements, several independently driven cabins or several cabins to be driven independently can be provided. This is in particular also possible if a mechanical drive such as a drive having a chain or spindle is used.

This results in reduced assembly times with an enhanced safety. Fewer components are required, also accompanied by a lower maintenance demand and reduced environmental pollution.

The load in this longitudinal strand is in principle transferred to the ground. If connections to the shaft are provided as described above in conjunction with the shaft element, a force can be transferred into the shaft wall, whereby larger heights can be achieved.

Because no counterweight is required anymore, smaller shaft sizes can be realized. Furthermore, the own weight of the required ropes is eliminated.

Other advantages and modifications of the invention will be understood with respect to the specification and the accompanying drawings.

It will be understood that the above-mentioned features and the features to be explained below can be used not only in the respective indicated combination but also in other combinations or individually without leaving the scope of the present invention.

The invention is schematically illustrated in the drawings with respect to embodiments and will be described below in detail with respect to the drawings.

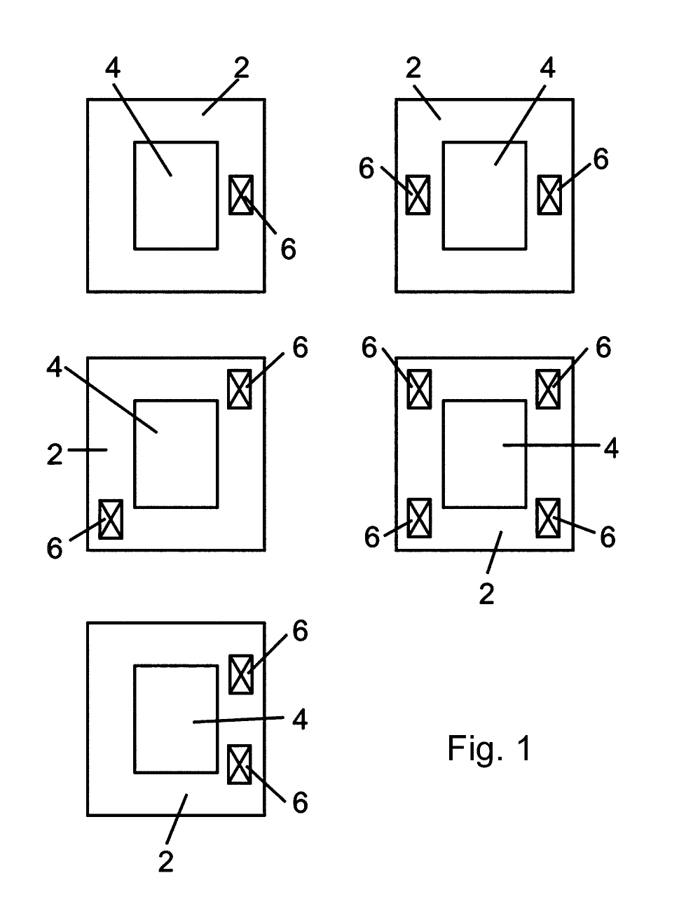

FIG. 1 shows a very simplified illustration of possible arrangements of longitudinal strands in an elevator shaft.

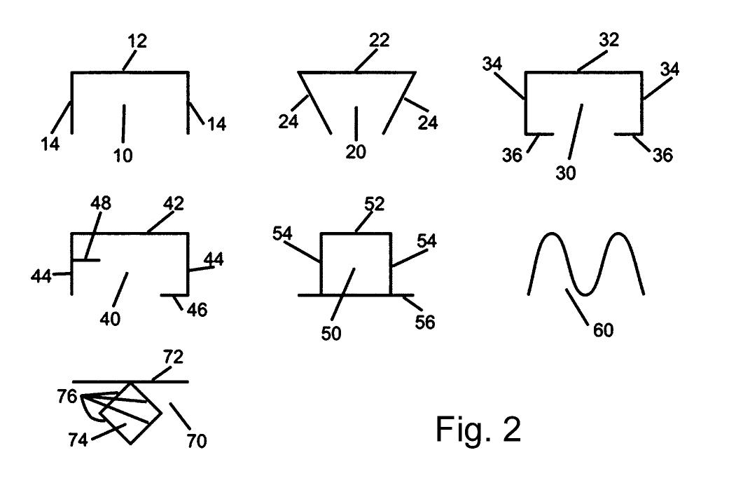

FIG. 2 shows possible cross-sections of the described longitudinal strand.

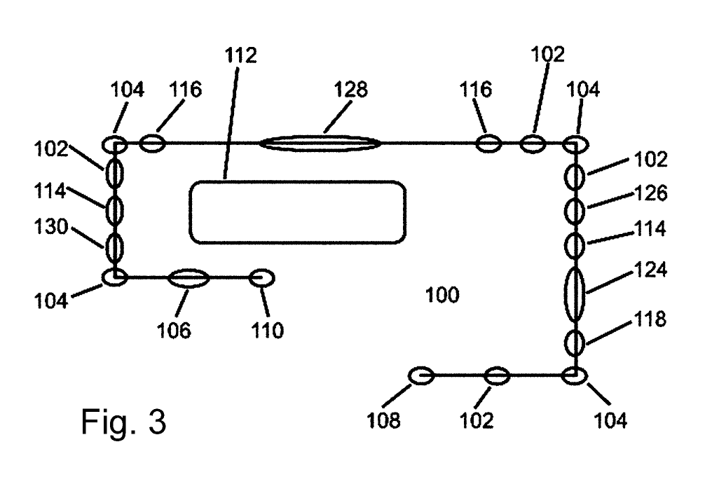

FIG. 3 shows a possible cross-sectional profile of the longitudinal strand illustrating partitions for different functions.

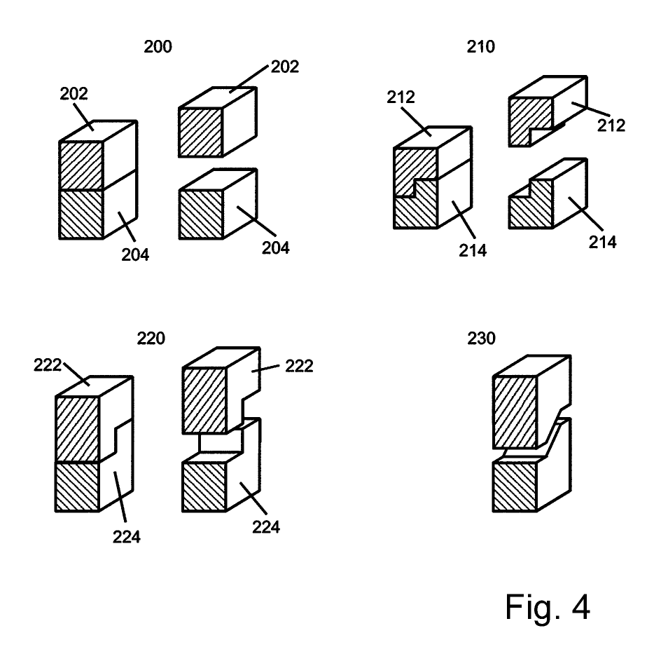

FIG. 4 shows joint areas between longitudinal strand elements.

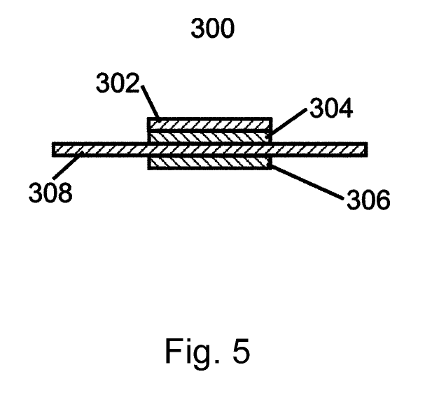

FIG. 5 shows a partition of the longitudinal strand for a braking surface.

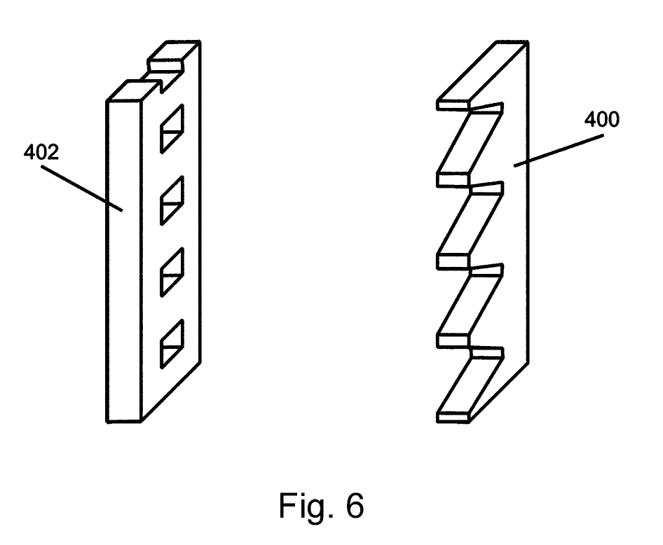

FIG. 6 shows partitions of the longitudinal strand for a main drive.

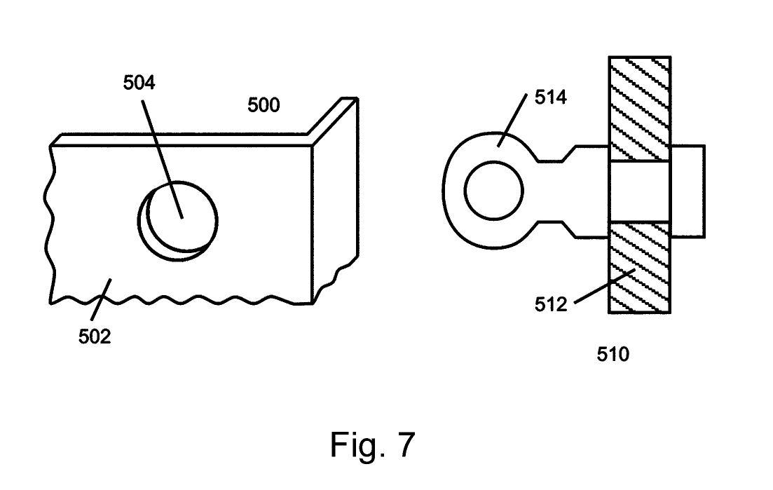

FIG. 7 shows a partition for a stopping means.

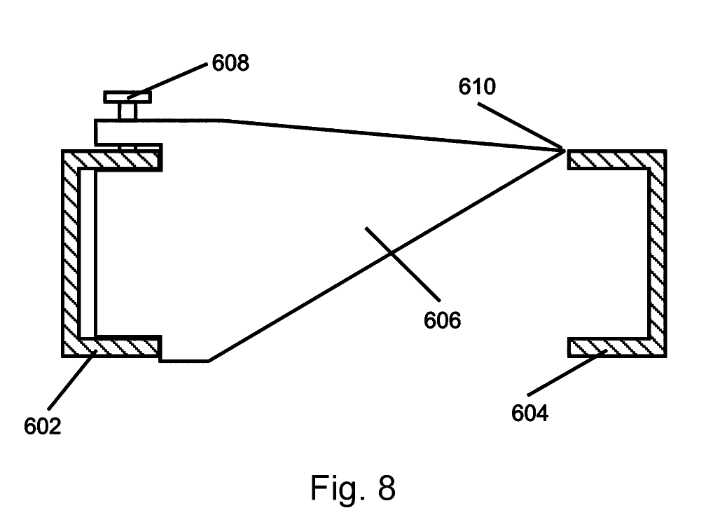

FIG. 8 shows a gauge for aligning a longitudinal strand in the shaft.

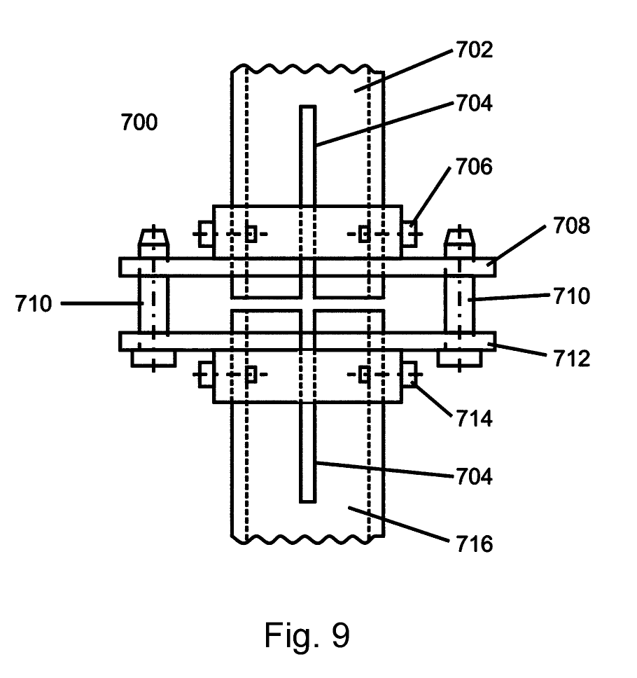

FIG. 9 shows a calibrating device.

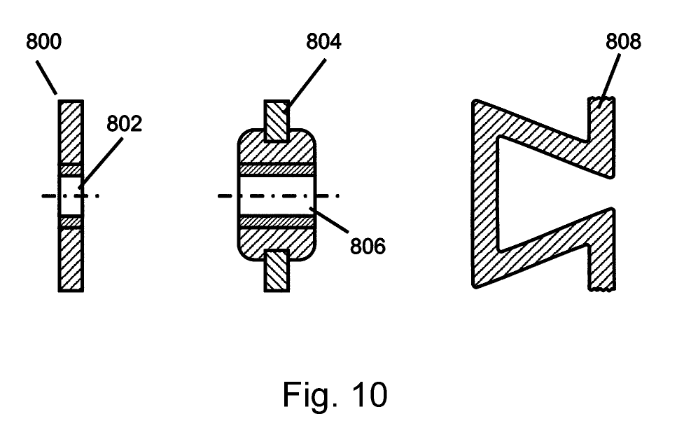

FIG. 10 shows mounting regions for other elevator components.

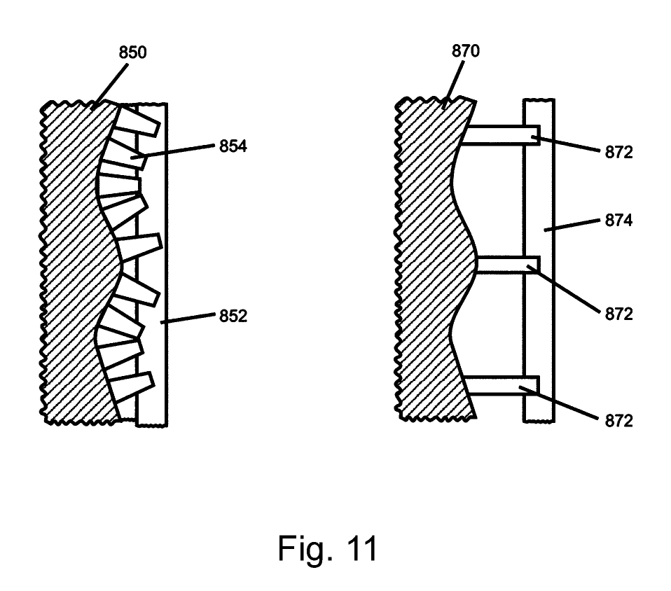

FIG. 11 shows connections in a shaft.

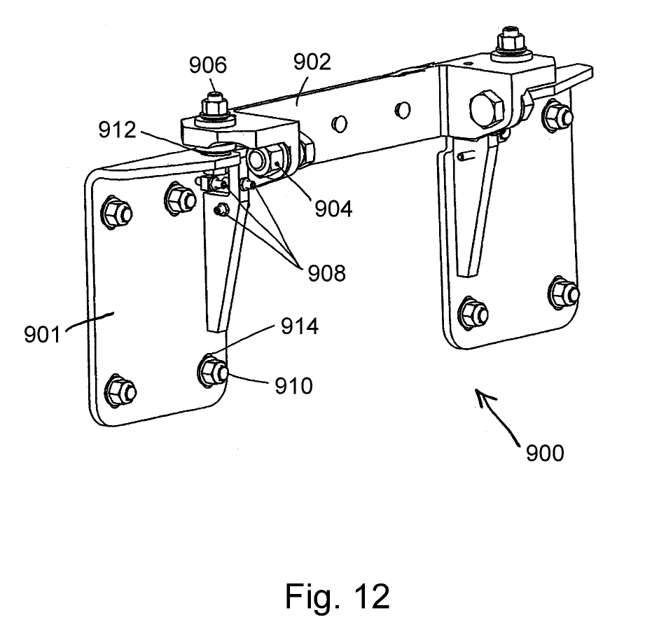

FIG. 12 shows a form-locking connection by means of a bracket.

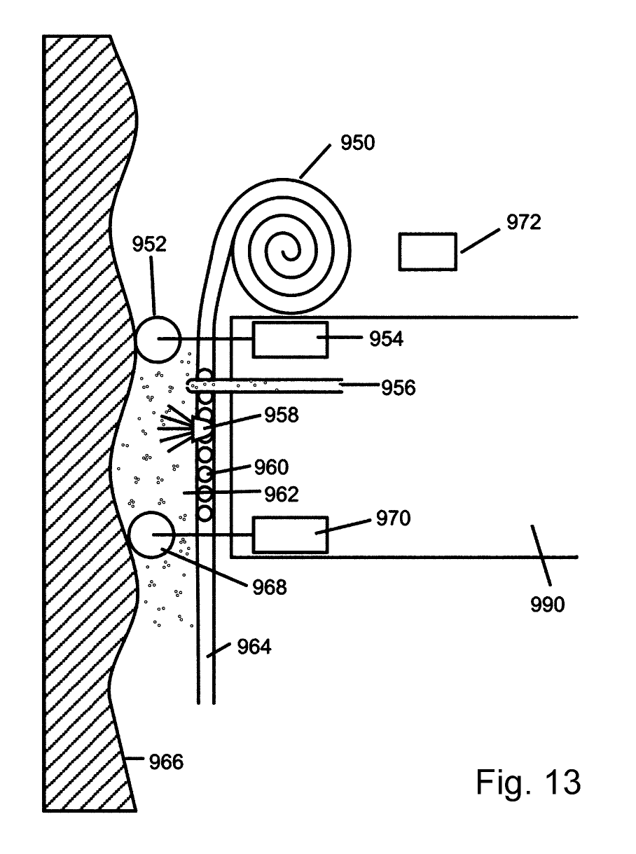

FIG. 13 shows a possible assembly sequence.

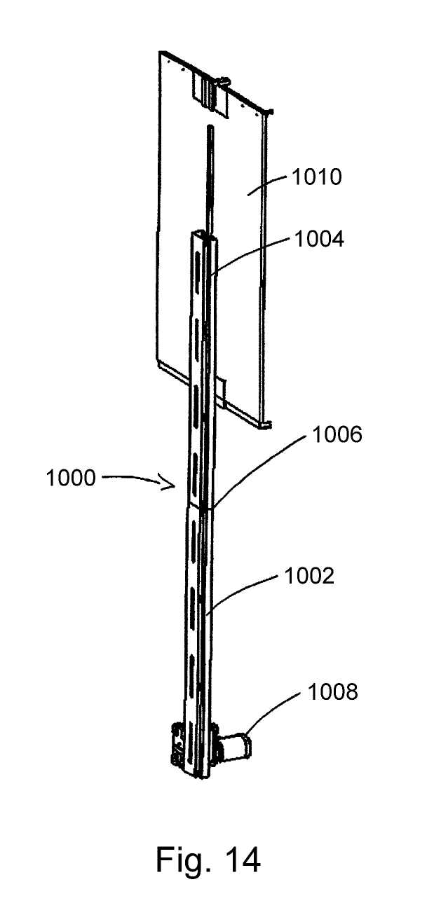

FIG. 14 shows a longitudinal strand.

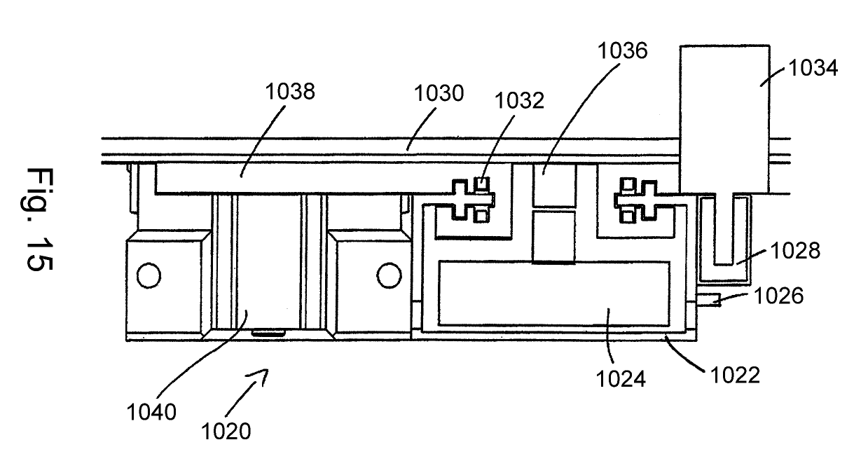

FIG. 15 shows a cross-section of a longitudinal strand element.

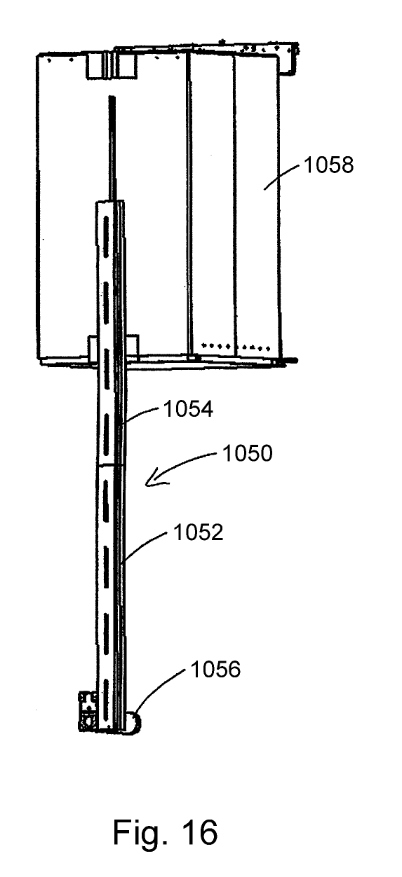

FIG. 16 shows a longitudinal strand with a cabin.

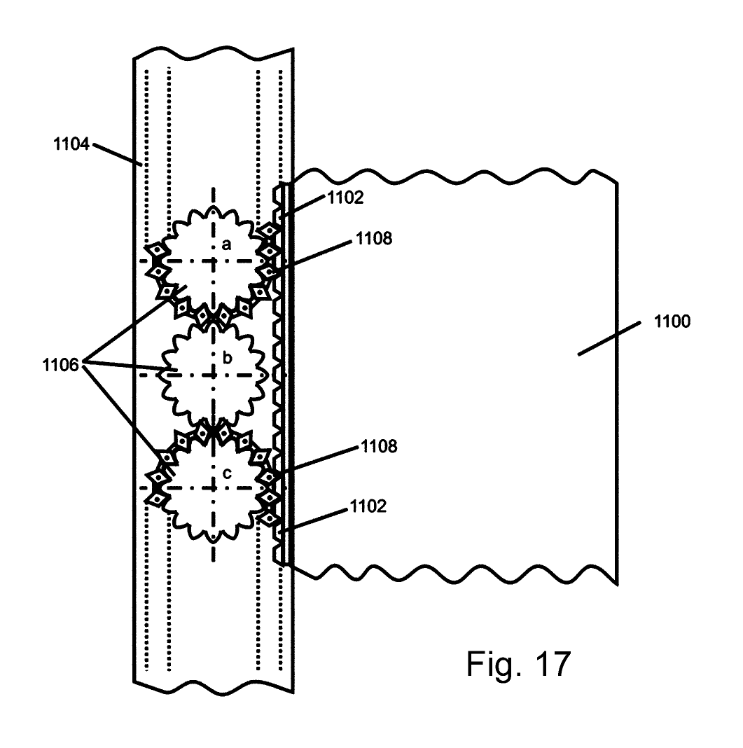

FIG. 17 shows a drive of a longitudinal strand element.

FIG. 1 illustrates five possibilities of arranging longitudinal strands in an elevator shaft.

The illustration shows an elevator shaft 2 comprising an elevator car 4, wherein at least one longitudinal strand 6 is arranged in the elevator shaft 2. Up to four longitudinal strands 6 are thus provided in the elevator shaft 2 which are arranged facing each other in the corners of the elevator shaft 2. If several longitudinal strands 6 are provided, a symmetrical arrangement of those in the elevator shaft 2 is favorable. Furthermore, positions for the longitudinal strands are possible which are mirror images of the positions illustrated in FIG. 1.

FIG. 2 shows different cross-sectional profiles of the presented longitudinal strand or the longitudinal strand element. These longitudinal strand elements which, if connected, form the longitudinal strand are attached by connections in the shaft.

The longitudinal strand is generally made of a thin-walled material. The cross-section of the profile can be closed or open as shown in FIG. 2.

Thus, a reference number 10 shows an open profile of a longitudinal strand having substantially a u-shape with a base 12 and two legs 14.

A reference number 20 shows a profile similar to the profile indicated by the reference number 10 also having a base 22 and two legs 24 converging towards each other.

A reference number 30 indicates another open profile having a base 32, two legs 34 orthogonally extending from this base, and two lateral brackets 36 each extending substantially orthogonally at opposite ends of the legs 34.

The profiles 10, 20 and 30 can each be formed by bending or by assembling individual plates or sheets.

A reference number 40 indicates another open profile having a base 42, two legs 44, a lateral bracket 46 and a rib 48.

Another profile 50 is configured in a closed form having a base 52 and two legs 54 which are connected to a base plate 56 so that the closed profile 50 is obtained.

A reference number 60 indicates another profile formed in a corrugated manner.

Furthermore, a reference number 70 indicates a closed profile comprising a base plate 72 having a connected rhombic rectangular unit 74 which is again composed of four plates 76.

The shown profiles illustrate that different cross-sections can be used for the longitudinal strand. Herein, the concrete configuration of the longitudinal strand is adapted to the particular requirements of the lift and the exterior conditions such as the space conditions in the shaft. The shown profiles represent only an arbitrary choice of possible profiles, and they can also be combined on demand.

FIG. 3 shows another possible cross-sectional profile of a longitudinal strand which as a whole is indicated by the reference number 100.

It should be noted that the presented longitudinal strand 100 is subdivided into different partitions to which the above-mentioned functions and the required materials are assigned in this configuration. The used materials can be steel, non-ferrous materials, plastics and fiber composite materials. The surfaces can conveniently be finished for this purpose.

Furthermore, each partition can be designed individually, or several partitions can be combined. FIG. 2 now shows the profile 100 having different partitions realizing the following functions.
Partitions 102: Providing running surfaces for the elevator car guides,
Partition 104: Providing emergency running surfaces for emergency running guides,
Partition 106: Providing braking surfaces for catching devices and/or braking devices,
Partitions 108: Providing engagement surfaces for main drives,
Partition 110: Providing engagement surfaces for emergency drives,
Partition 112: Integrating and protecting the drive components such as carrier means, e.g. a chain, friction wheels, cogwheels or linear motor components,
Partitions 114: Providing stopping points for lifting gears,
Partitions 116: Providing adjustment regions for controlling the correct alignment,
Partition 118: Providing sensor signals for controlling the perpendicular alignment,
Partition 124: Providing mounting regions for further elevator components such as a shaft encoder and/or a shaft illumination and/or a lift cable attachment and/or linear motor components etc.,
Partition 126: Providing a code for a shaft position encoder,
Partition 128: Providing connecting elements for attachment at the shaft,
Partition 130: Providing transmission media for data and energy.

FIG. 4 shows joint areas between longitudinal strand elements. Depending upon the lifting height, the longitudinal strand is fabricated integrally or in individual elements or segments. The transition areas between the segments are designed so that they enable a posterior substitution of individual segments within the already mounted longitudinal strand.

For the partitions requiring an even continuation of the surfaces, the transition area has an overlapping design. The transition areas can be designed in the following manner:

A reference number 200 indicates a transition in which a first element 202 and a second element 204 lie on top of each other with smooth bearing surfaces.

A reference number 210 shows a transition in which a first element 212 and a second element 214 lie upon each other with correspondingly stepped bearing surfaces so that the transition area has an overlapping design.

A reference number 220 indicates another overlapping transition having a first element 222 and a second element 224.

Another stepped transition having an inclination in the bearing surfaces is designated by a reference number 230.

The transition or the transition area can also be designed as a combination of two or more principles.

The individual components of the longitudinal strand can be fabricated by individually cutting or stamping the blanks of the individual components of sheet-metal plates or so-called tailored blanks and subsequently canting or shaping the same. Alternatively, the individual components can be fabricated from tubes which are pressed to their final shape by means of internal high-pressure forming. Other alternative procedures provide that the individual components are fabricated from flats which are shaped by means of an extrusion facility and subsequently cut to length, that the individual components are discontinuously fabricated as individual fiber-composite components or that the profiles of the individual components are formed by means of a pultrusion technology and subsequently cut to length.

At the ends of the longitudinal strand segments, further partitions are located which are orthogonal to the cross-section of the longitudinal strand segments.

Those are a partition for providing compensation regions for potential building subsidences and a partition for providing compensation regions for potential temperature expansions.

FIG. 5 shows a partition 300 of the longitudinal strand for a braking surface. This braking surface substantially consists of a support material for the braking surfaces and a filling material. The characteristics of the braking surfaces can be different from the rest of the longitudinal strand. By changing the thickness of the filling material, the geometry can be varied.

FIG. 5 shows the exact structure of the partition 300 having an upper braking surface 302, a filling material layer 304 and a lower braking surface 306. Between the lower braking surface 306 and the filling material layer 304, the rest of the longitudinal strand 308 is located.

FIG. 6 shows potential partitions of the longitudinal strand for a main drive.

The partition for the main drive can be characterized in that the surface friction value has been enhanced and/or a toothing 400 or a hole pattern 402 has been incorporated. In this case, the partition can be configured for an emergency drive according to the partition for the main drive.

FIG. 7 shows potential partitions for a stopper means which are preferentially arranged in the center-of-gravity axis of the longitudinal strand.

The illustration shows a section 500 of a longitudinal strand 502 having an opening 504 as a first option.

In another variation 510, an eye 514 is anchored in a base body 512 of a longitudinal strand.

The longitudinal strand can have partitions used for aligning the longitudinal strand in the shaft. For this purpose, gauges or measurement devices can be mounted at defined locations of the partition. This is illustrated in FIG. 8.

The illustration shows a left longitudinal strand 602 and a right longitudinal strand 604 between which a gauge 606 is arranged for alignment purposes. This gauge 606 is fixed at the left longitudinal strand 602 by means of a clamping device 608. A tip 610 of the gauge 604 serves for aligning the right longitudinal strand 604 or the left longitudinal strand 602.

Alternatively, elements to which reference can be made or which can process signals and by use of which the present position of the longitudinal strand can be determined can be incorporated into the partition. Those can be inclination sensors, for example, which are laid into the fiber composite and which can be read out wirelessly, for example.

If the longitudinal strand is made of individual segments, calibrating devices leveling the cross-sections of the profiles with respect to each other can be located at the ends of the segments. Such a calibrating device is shown in FIG. 9 and as a whole designed by reference number 700.

The illustration shows an upper longitudinal strand element 702, a compensation slot 704, a first connection 706, an upper calibration sleeve 708, alignment bolts 710, a lower calibration sleeve 712, a second connection 714 and a lower longitudinal strand element 716.

For the alignment, the precisely manufactured calibration sleeves 708 and 712 are put over the ends of the longitudinal strand elements 702 and 716 and connected to them. In order to improve the leveling between the ends and the calibration sleeves 708 and 712, the ends can also be provided with slots such as the compensation slot 704. In the assembly process, one of the calibration sleeves 708 and 712 is brought into agreement with the other by means of the alignment bolts 710. In this manner, a stepless transition can be realized.

The longitudinal strand can include partitions serving as mounting regions for other elevator components such as a shaft position encoder and/or a shaft illumination and/or an elevator cable attachment and/or linear motor components, etc. For this purpose, grooves, bores or threads can be formed in the longitudinal strand. FIG. 10 shows potential configurations for those.

The illustration shows a first longitudinal strand having a bore 802, a second longitudinal strand 804 having a threaded fitting 806, and a third longitudinal strand 808 which is provided with grooves.

Furthermore, the longitudinal strand can have a partition used for the lift encoder, wherein it serves as a running surface for an accompanying speedometer or is provided with a coding which can be read out by a moving partial system. This coding can be applied to the longitudinal strand in the form of a coded strip, or it can be incorporated into the longitudinal strand. Instead of a strip, individual reference points such as transponders can be used as well. However, the coding can also be realized by differently coating, magnetizing or perforating the partition.

Furthermore, the longitudinal strand can have a partition which autonomously transports data or energy or into which lines transporting data or energy are incorporated. If the longitudinal strand should be divided into elements or segments, the transition areas of the segments or lines are configured so that they transport the data or energy onwards. This can be realized by plug connections, for example.

Sensors being able to detect bendings or material deteriorations can be incorporated into or applied to the longitudinal strand. Those can be DMS which can be read out wirelessly. Thereby, statements over the state of the longitudinal strand can be made.

The longitudinal strand is typically attached to the shaft by means of a connection. This connection regularly compensates any unevenness of the shaft wall and guarantees a secure support of the longitudinal strand. Here, the connection can consist of a single continuous element or of several elements distributed over the longitudinal strand.

FIG. 11 shows possible connections in the shaft. At the left side of the Figure, a shaft 850 having a longitudinal strand 852 is shown, wherein the longitudinal strand 852 is connected to the shaft 850 by means of a continuous connection 854.

The connection 854 is configured so that any unevenness of the shaft 850 is compensated, and it is thus flexibly configured, for example.

At the right side, a shaft 870 is illustrated to which a longitudinal strand 874 is connected by means of individual distributed connections 872.

The connection or the connections fix the longitudinal strand in the horizontal directions and enable a vertical sliding movement. According to one particular embodiment, the connection also fixes the vertical direction. The connection can be force-locking by means of adhesive materials or form-locking by means of adjustable clamps or brackets.

If adhesive materials are used, the longitudinal strand is brought into the correct position. Subsequently, the space between the longitudinal strand and the shaft wall is filled with adhesive or foam. After the connection has hardened, the further assembly is continued. This process can also be carried out continuously.

FIG. 12 shows a form-locking connection by means of brackets. The illustration shows a connection 900 having a calibration sleeve 902, a first connecting element 904 for the longitudinal strand, a second connecting element 906 to the bracket 901, set screws 908 and fastening screws 910 for the attachment at the shaft wall.

A reference number 912 illustrates the horizontal adjustment region, and a reference number 914 illustrates the vertical adjustment region.

In the case of larger lifting heights, the longitudinal strand can conveniently be supplied to the shaft in a flexible condition, preferentially in a rolled up condition, where it is rolled out and brought into the correct position and subsequently fixed. The fixation can be carried out by evacuating or by blowing in air or by curing. The curing can be carried out by means of ultraviolet light, air components or by supplying a chemical accelerator.

FIG. 13 illustrates a possible assembly sequence in case the connection is realized by an adhesive material.

The illustration shows a flexible rolled up longitudinal strand 950. It is located together with a dispenser 956, an ultraviolet lamp 958 and a guide 960 on a mobile assembly platform 990 which is driven by a friction wheel drive 952 and 968 and perpendicularly lifted up by pressure cylinders 954 and 970.

The adhesive material is applied by the dispenser 956 and cured by an ultraviolet lamp 958. The adhesive material is cured 962 behind a guide 960 of the longitudinal strand and fixed in the lower region 964 of the longitudinal strand at the shaft wall 966.

Furthermore, a controller 972 for controlling the process is provided.

FIG. 14 shows a longitudinal strand generally indicated by the reference number 1000. This longitudinal strand 1000 comprises two longitudinal strand elements 1002 and 1004 which are connected at a joint area 1006. At the lower part of the longitudinal strand 1000, a motor 1008 for driving a cabin 1010 is provided.

FIG. 15 shows a cross-section of a longitudinal strand 1020. It comprises a main element 1022, a drive element 1024, a shaft illumination 1026 such as an LED, and a power and/or data rail 1028 forming a unit. An additional suspension cable or additional suspension cables can be dispensed with if the power and/or data rail 1028 is used.

Furthermore, a cabin 1030, a catching device 1032, a distributor (counterpart of the power rail) 1034, a power input device 1036, a guide 1038 and a drive unit 1040 including a controller can be recognized.

FIG. 16 shows a longitudinal strand 1050 having two longitudinal strand elements 1052 and 1054, a motor 1056 and a cabin 1058.

FIG. 17 shows a cabin 1100 having a rack 1102 as a power input device and a longitudinal strand element 1104. In the longitudinal strand element 1104, cogwheels 1106 are provided as drive elements. The central cogwheel 1106b serves for coupling the two other cogwheels 1106a and 1106c. Additionally, silent chains 1108 are provided for power transmission. The cogwheels 1106 can be driven directly or via a common drive.

The illustrated longitudinal strand element 1104 can further comprise a positioning unit, a power and data rail, a shaft illumination, other drive elements, a maintenance device and/or an assembly position device. The coupling of the longitudinal strand elements 1104 can also be realized externally by means of an additional chain or clutch.

1-24. (canceled)

25. Coupling element for coupling two longitudinal strand elements for a shaft of an elevator system, comprising:
means for force transmission between the two longitudinal strand elements.

26. Coupling element for coupling two longitudinal strand elements for a shaft of an elevator system, comprising:
means for force transmission between the two longitudinal strand elements; and
said means includes a cogwheel.

27. Coupling element according to claim 26, wherein the cogwheel is operatively coupled to cogwheels provided in the longitudinal strand elements.

28. Coupling element according to claim 26, wherein the cogwheel is driven directly.

29. Coupling element according to claim 26, wherein the cogwheel is driven by a common drive.

30. Coupling element according to claim 25, and further comprising valves.

31. Coupling element according to claim 26, wherein at least one partition in the longitudinal strand element is provided to which an active function is assigned.

32. Longitudinal strand element for a shaft of an elevator system, comprising:
the longitudinal strand element is divided into a plurality of partitions to each of which a function is assigned;
at least one partition is provided to which an active function is assigned; and
a drive function is assigned to at least one partition.

33. Longitudinal strand element according to claim 32, wherein the drive function is a mechanical drive.

34. Longitudinal strand for a shaft of an elevator system, comprising:
a number of longitudinal strand elements;
the longitudinal strand elements are divided into a plurality of partitions to each of which a function is assigned;
at least one partition is provided to which an active function is assigned; and
a drive function is assigned to at least one partition.

35. Longitudinal strand according to claim 34, wherein joint areas are formed between longitudinal strand elements at least limited to individual partitions in an overlapping manner.

36. Longitudinal strand according to claim 34, and further comprising a coupling element between at least two of the longitudinal strand elements.

37. Longitudinal strand according to claim 36, wherein a silent chain coupling cogwheels is provided.

38. Method for assembling a longitudinal strand for a shaft of an elevator system, wherein a first longitudinal strand element is mounted, then a drive is mounted, then a subsequent strand element is mounted via a coupling element.

39. Method for mounting a longitudinal strand according to claim 38, wherein a cabin is mounted.

40. Method for mounting a longitudinal strand according to claim 39, wherein the cabin is fixed by means of an assembly positioning device.

41. Method for mounting a longitudinal strand according to claim 39, wherein the cabin serves as a working platform.

42. Method for mounting a longitudinal strand according to claim 39, wherein the drive to be mounted is a driven cogwheel.
